(19) United States
(12) Patent Application Publication
(10) Pub. No.: US 2016/0099966 A1
(43) Pub. Date: Apr. 7, 2016

(54) DISRUPTING AUTOMATED ATTACKS ON CLIENT-SERVER INTERACTIONS USING POLYMORPHIC APPLICATION PROGRAMMING INTERFACES

(71) Applicant: Shape Security, Inc., Palo Alto, CA (US)

(72) Inventor: Siying Yang, Cupertino, CA (US)

(21) Appl. No.: 14/968,460

(22) Filed: Dec. 14, 2015

Related U.S. Application Data
(62) Division of application No. 14/329,718, filed on Jul. 11, 2014.

(51) Int. Cl. H04L 29/06

(52) U.S. Cl. CPC H04L 63/1466; H04L 67/42

(57) ABSTRACT

An app interacts with a human user of a user device that is executing the app while the app is also interacting over a network connection to an API server by making API calls to the API server and using the responses. An intermediary is provided between the API server and user devices/clients that modifies application programming interface interactions to disrupt automated attacks on those client-server interactions, at least as to those API interfaces that are known to be human-interaction API interfaces. The human-interaction API calls are disassociated to thwart automated attacks using those API calls. The disassociation can be provided through the use of user interface builder packages to provide instructions to the app as to performing human user interaction. Disassociating can be done by separating labels from their meaning, such as by assigning random values to the labels or other methods of obfuscating relations and structure.

### FIELD OF THE INVENTION

The present invention relates generally to network computer system security and more particularly to defense against some automated attacks on the network computer system.

### BACKGROUND

The Internet (and related networks) can be used to send e-mails, conduct business, automate machinery and used for data processing. Connected users can use the Internet to interact with other connected users and/or connected computer systems. Some of the Internet traffic is wanted by the parties involved, but other traffic is unwanted by at least one party. For example, by some estimates, more than three quarters of daily e-mail volume over the Internet is unwanted by its targeted recipient (sometimes referred to as “spam”). More than just e-mail traffic is unwanted by its targeted recipient. For example, banks, bank customers, and bank network operators and managers do not want traffic that is attempting to break into a bank's online banking system. Of course, in today's world, there is some traffic that is wanted and/or necessary, so one task that online systems operators have to deal with is separating the wanted traffic from the unwanted traffic, letting the wanted traffic through and blocking the unwanted traffic.

For example, the typical e-mail recipient does not want to receive all unsolicited commercial offers. The online network operator that limits access to resources to authorized users does not want to receive traffic from unauthorized users. Unfortunately, the initiators of such unwanted traffic really want to send it, and will attempt to do so even if it requires getting around limits and controls placed by the online network operator. This creates an “arms race” between the initiators of unwanted traffic and the online network/systems operator.

There are many reasons a sender of unwanted traffic might want to initiate the traffic. Often, those are financial reasons. For example, if a scammer can send out one million e-mails with a total expenditure of less than ten dollars and a half hour of time, and reap a few dollars in profits from just 0.01% of the e-mail recipients, it is cost-effective for the scammer to do so. If an criminal organization can apply 100,000 username-password pairs to an e-commerce website to find the 0.01% that are vulnerable, they would do so if the monetary returns from hacking ten user accounts is greater than the cost to the criminal organization of obtaining the username-password pairs plus the cost of executing 100,000 attempted logins.

These unwanted attacks could be thwarted using guaranteed secure methods to filter out unwanted/unauthorized traffic from wanted/authorized traffic. However, as illustrated from the examples above, even a 99.99% success rate at blocking attacks would still allow enough traffic through to be a cost-effective attack. Some of this economics comes about because automation lowers the cost of transactions. Ironically, the very automation that makes it economically feasible for a bank, retailer, music distributor, online storage vendor, etc. to provide a low-cost service to millions of its customers also makes it economically feasible for a criminal or criminal organization to make millions of attempts to get at network resources in an unauthorized way.

If the effort required to mount an attack on a network resource can be raised so that it is uneconomical to attack (but still easy enough for authorized users to access), the attacks might be reduced. Therefore, it would be desirable to increase the efforts/costs of access to the network resource in a way that makes it uneconomical for an organization to mount an attack on network resources, while allowing authorized uses.

The typical web client-server interaction involves a user having a device that runs a web client (such as an Internet browser) communicating with a web server using the Hypertext Transport Protocol (“HTTP”). For example, the web client might make a specific request of a web server by sending that web server a structured HTTP request and the web server might respond with an HTTP response comprising a Hypertext Markup Language (“HTML”) document, which the web client then “renders” to form a displayable form of the HTML document (e.g., a web page) viewable by the user of the web client (or the device executing a software web client). Other applicable protocols might include API calls that use HTTPS, JavaScript, CSS, XML, JSON, or other forms of web traffic or web content.

While this approach is efficient and allows for one HTML document to be viewable over a wide variety of web clients, devices executing the web clients, displays, interfaces, etc., the structured nature of HTML documents provides an opportunity for automated attacks. The structured nature of the communication provides, in effect, an application programming interface (“API”) that programs (legitimate or otherwise) can use to automate HTTP interactions so that those programs can stand in the place of a human user of a device that executes a human-interface web browser.

When any eavesdropper can easily discern, in an automated fashion, how to falsify an apparently valid HTTP request that appears to be coming from a legitimate web client, how to automate the equivalent of a human user interaction (but much faster and for longer), and how to extract valuable information from the HTML pages sent in reply to HTTP requests, this can be a problem as some attacks that are too costly to mount are done using computers instead of human actors.

Various methods (e.g., reference polymorphism) can be used to block automated attacks on HTTP/HTML traffic, or at least to raise the effort needed beyond an attacker's breakeven point. Some of these methods will reduce the availability of the “unintentional API” that HTTP/HTML provides.

For intentional APIs, i.e., an API that the server operator, by design, intends to interact with computer-based clients making server requests (as opposed to only human users initiating such server requests). In such cases of intentional APIs, modifying interactions so that only human users can interact with the server and computer processes cannot easily interact with the server would tend to frustrate the purpose of the intentional API.

One scenario where intentional APIs are common is in the use of web “apps”, which are specific purpose programs that have a communication component. For example, an interactive game on a mobile device might be an app. An app might communicate with a corresponding server using HTTP using a defined intentional API. While this might provide more user experience features than would be available with a browser interface, it means that the app will often be making structured API calls. Thus, an attacker that is blocked from automating an attack on web client to web server interactions involving HTTP/HTML in the clear may turn to automated attacks on APIs. It would be desirable to allow legitimate API traffic while blocking illegitimate API traffic.

### SUMMARY OF THE EMBODIMENTS

A server services responses to requests received, via a network, from clients executed by user devices. The user device requests are in the form of application programming interface calls (“API calls”). In a typical operation, the app is interacting with a human user of the user device that is executing the app while the app is also interacting over a network connection to a server, an API server, by making API calls to the API server and using the responses. An intermediary is provided between the API server and user devices/clients that modifies application programming interface interactions to disrupt automated attacks on those client-server interactions.

In some embodiments, the API comprises a set of possible API calls wherein some of the possible API calls are designated as “human-interaction” API calls and others are designated as “computer-interaction” API calls. A human-interaction API call is a type of API call where the initiation of the call can be presumed to be the result of a human interaction with the app, whereas a computer-interaction API call is a type of API call where the initiation of the call is more typically the result of some processing that is happening in the app. The human-interaction API calls are modified to thwart automated attacks using those API calls through disassociation. Disassociating can be done by separating labels from their meaning, such as by assigning random values to the labels and maintaining a separate mapping to determine labels from those random values, or other methods of obfuscating relations and structure.

In specific embodiments, the disassociation provided through the use of user interface builder packages (“UIBPs”). A UIBP provides the necessary details for the app to construct a particular user interface to get the human input-output-etc. that the app requires for a given set of one or more human-interaction API calls. The UIBPs can be generated at the app server and sent to the app as needed, via the intermediary. The app is configured to make or process calls to a local user interface builder and provide a UIBP at the appropriate time so that the app can generate and operate the needed human user interface. In this manner, an app can run, provide a user interface for human interaction, and interface to an API server, while making it difficult for an attacker to automate the human interaction needed to operate the app.

The following detailed description together with the accompanying drawings will provide a better understanding of the nature and advantages of the present invention.

### BRIEF DESCRIPTION OF THE DRAWINGS

FIG. 1 is a block diagram of an app-API server system illustrating an example new app interaction process and various elements.

FIG. 2 is a flow diagram of an HI-API (human-interaction API) initialization process.

FIG. 3 is a swim diagram illustrating interactions of an app, an intermediary, and an API server.

FIG. 4 illustrates an example of a reference for a human-interaction API.

FIG. 5 illustrates an example of a user interface builder package (“UIBP”), in pseudo code form, as might be sent from an API server.

FIG. 6 illustrates an example of a user interface builder package (“UIBP”), transformed by an intermediary for use by an app to generate user interface elements.

FIG. 7 is a block diagram of a larger system comprising a plurality of clients and a plurality of servers.

In the figures, like reference symbols in the various drawings indicate like elements, and multiple instances of objects might be denoted parenthetically (e.g., 101(1), 101(2), . . . , 101(n)). Where numbered objects in figures are shown with parenthetical sub-numbers ranging from 0 or 1 up to some letter designation (e.g., “1, 2, . . . , k” or 1, 2, . . . , n″), it should be understood that the letter designation represents some finite number the value of which is not essential for the understanding of the invention, unless otherwise indicated.

### DETAILED DESCRIPTION

Network resources might include information, financial value, computing resources, or the like. For example, online-stored e-mails, online-stored personal photo, bank accounts with online transfer capability, online shopping services, computing power, etc., are all forms of network resources.

Network services might include uploading data, downloading data, interacting with server-side programs over a network, access to physical resources (e.g., printers, cameras, other equipment, etc.), communication services, or similar services that might be provided over a network. Network services might be provided by an HTTP server coupled to a back-end data processing system, or the like. Other network protocols might be used, as appropriate.

The network can be the Internet, an intranet, an extranet, a LAN, WAN or similar network that connects computers/devices/systems at network nodes to at least some other network nodes, thereby allowing users to use the network services.

As used herein, at least for the sake of readability, participants in a transaction might be referred to as a “user” and a “network service provider” but it should be understood that these labels might sometimes refer to humans or computers as users and/or persons, business groups, organizations, etc. as network service providers, even though specifically and technically it may well be that an electronic device operated by, or at the behest of, a user is what is doing the interaction and the interaction is with computer/electronic hardware operated by, or at the behest of, a network service provider.

Electronic user devices might include computers, tablets, wearable computer devices, smartphones, embedded computer systems, or other devices.

Also, for the sake of readability, explanations are provided in the context of a user/user device running a “native mobile app” that executes on a user device, interacts with a human user, and also interacts over a network with a server using API calls according to an API expected by the API server. Unless otherwise indicated, the app can be a program running at the user device in user space, in system space, in browser space, etc. and can be a simple or complex program with a general or specific purpose.

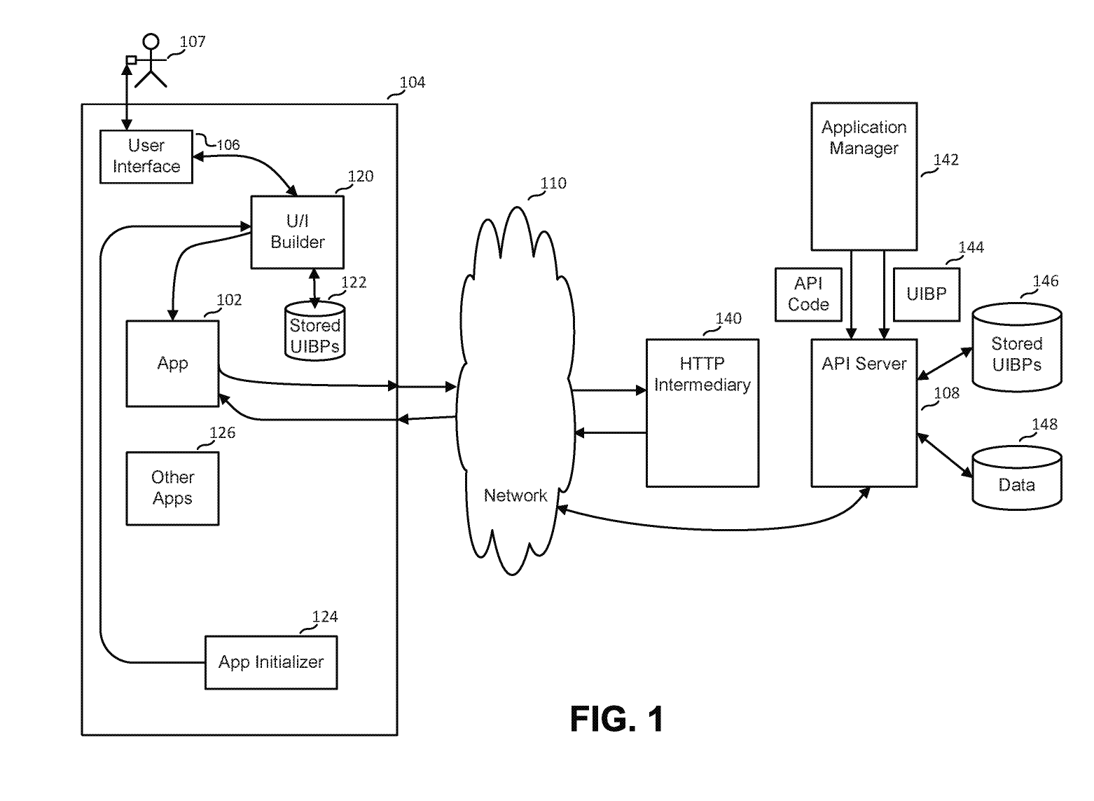

FIG. 1 is a block diagram of an app-API server system illustrating an example new app interaction process and various elements. In the example shown there, an app 102 executed by a user device 104 can perform input-output operations with respect to a user interface 106 to present information to a user 107 and obtain information from user 107. App 102 also interfaces to an API server 108 across network 110. Note that when the app-API server system is designed to allow a large number of user devices/apps to interact with the API server, it can be possible that some of the user devices/apps are operated by persons or entities not authorized to access the API server and it can be possible that some of those unauthorized accesses are in the context of an app running with the user interface replaced with an automated process.

For example, consider a travel planning app. The app might ask a user to select a destination among various destinations and a date, then the app would send an API call to the API server asking for the data associated flights to the selected destination and selected date. The API server would then reply to the app with that data, and the app in turn might perform some internal processing (such as checking the user's calendar for conflicts, calculating taxes, comparing user preferences, etc.) and possibly provide some user interface output (e.g., the message “We found 15 flights matching your query, and 9 are non-stops. Would you like more information?”). With many such apps, this is a legitimate use.

Now, suppose that a programmer wrote an attacking app to make API requests for all known destinations, for all serviced airlines, for a large range of dates. With the collected responses, the programmer could have the app build a complete flight information database. With many such attacking apps, this is not a legitimate use. Note that while it might also be an illegitimate use to hire someone to sequentially type in all known destinations, etc., into the original legitimate app, often the fact that such an approach is not cost-effective relative to the programmer's goals precludes this from actually occurring.

As explained in more detail herein, by making the user interface portion of the app's interaction be difficult to replicate and the app's interaction with the API server difficult to understand, building an attacking app to make these API calls in an unauthorized fashion might be rendered cost-ineffective.

Referring again to FIG. 1, before API server 108 is to serve up responses for a particular app (immediately before or some time before), API server 108 obtains API code for handling API calls and a user interface builder package (“UIBP”) 144 from an app manager 142. API server 108 might store the UIBPs into storage 146. As should be understood, storage elements might comprise local or distributed storage, hard disk memory, flash memory, RAM, or other elements. API Server 108 might also have access to other data storage 148.

Also shown in FIG. 1 is an intermediary 140, such as an HTTP intermediary. In some embodiments, the intermediary might be other than an HTTP intermediary, if other protocols are used. As illustrated, messages/traffic from user device 104 flow across network 110 to intermediary 140 and then to API server 108, and messages/traffic from API server 108 flows through intermediary 140 and network 110 to user device 104. It may also be that there are other elements (not shown) that are intervening elements, such as routers, computers, another network, and the like. Network 110 might be the Internet, some subclass of internet, or other type of network. API server 108 might also be connected to network 110 such that it bypasses intermediary 140. A common threat model for illegitimate automated use is where there are many legitimate users online sending API calls to API server 108 with some illegitimate users also online sending API calls to API server 108. There are other potential security threats to the system, such as a hacker hacking directly into app manager 142 or API server 108, but those threat models need not be discussed here.

FIG. 1 also provides some detail of example user device 104. User device 104 might be a computer, television, pager or other electronic device, but it might also be a smartphone carried by a user and used often, such that the smartphone can run various apps and perhaps the user device can select which apps to have installed and which to execute. For the user device that is a full-powered computer setup—such as a full keyboard, AC power, large monitor, etc.—it may well be that most network-interactive activities of the user are done via web interfaces wherein the user interacts with a browser display and the network interactions involve the browser making requests of a server. However, for the user device that is a more mobile, smaller, lower-powered, lighter device, it might be that to obtain all of the app developer's desired functionality and so an app is provided to the user device instead of having to rely on just a web browser interface.

User device 104 would typically be able to execute other apps 126 in addition to the one app 102 described in many of these examples. As will be described in more detail below, user device 104 includes an app initializer 124, a user interface builder module 120 and storage for UIBPs 122. App 102 and other apps 126 might be code/instructions in a form executable directly or indirectly by user device 104.

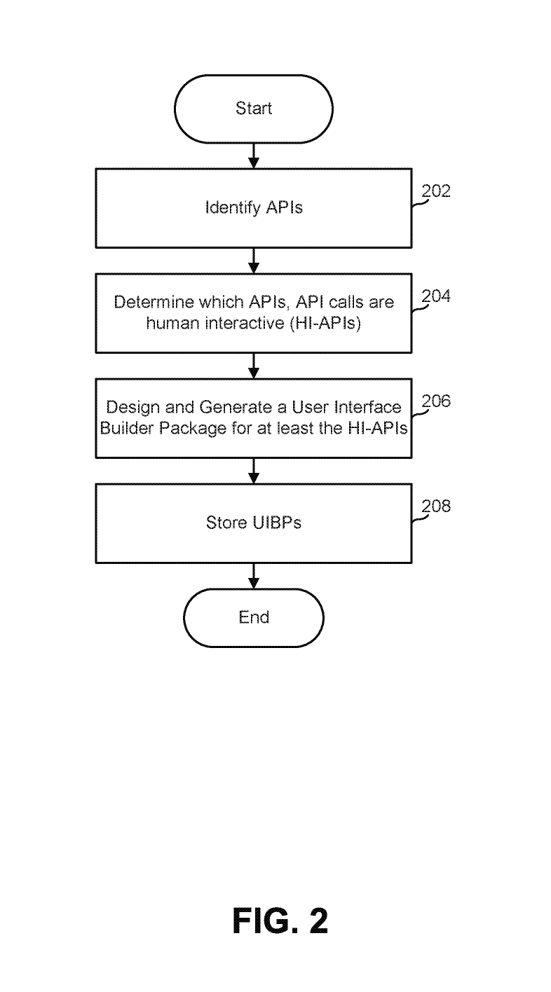

FIG. 2 is a flow diagram of an HI-API (human-interaction API) initialization process. As illustrated there, the HI-API initialization process begins with an app manager identifying APIs (step 202). The app manager can be a separate process and/or machine, such as app manager 142 of FIG. 1, or the app manager might be combined with other processes and/or machines. For example, the app manager might be integrated into an API server.

From the identified API calls, the app manager determines which API calls are human-interaction API calls (step 204). Steps 202 and 204 might be done heuristically, such as the case where not all of the API is documented, but might also be done by the app manager reading in a data file that provides header information for all allowed API calls and their various parameters.

The app manager then designs and/or generates a user interface component corresponding to the HI-API calls (step 206). Those user interface components are then stored (step 208) for later use by an API server when a native app starts up and sends a request for the UIBP for that app. In other variations, the user interface components are generated as needed, but in embodiments where there will be many users of an app, it would be more efficient to store the user interface components once and reuse them, as the HI-API call set typically does not change very frequently.

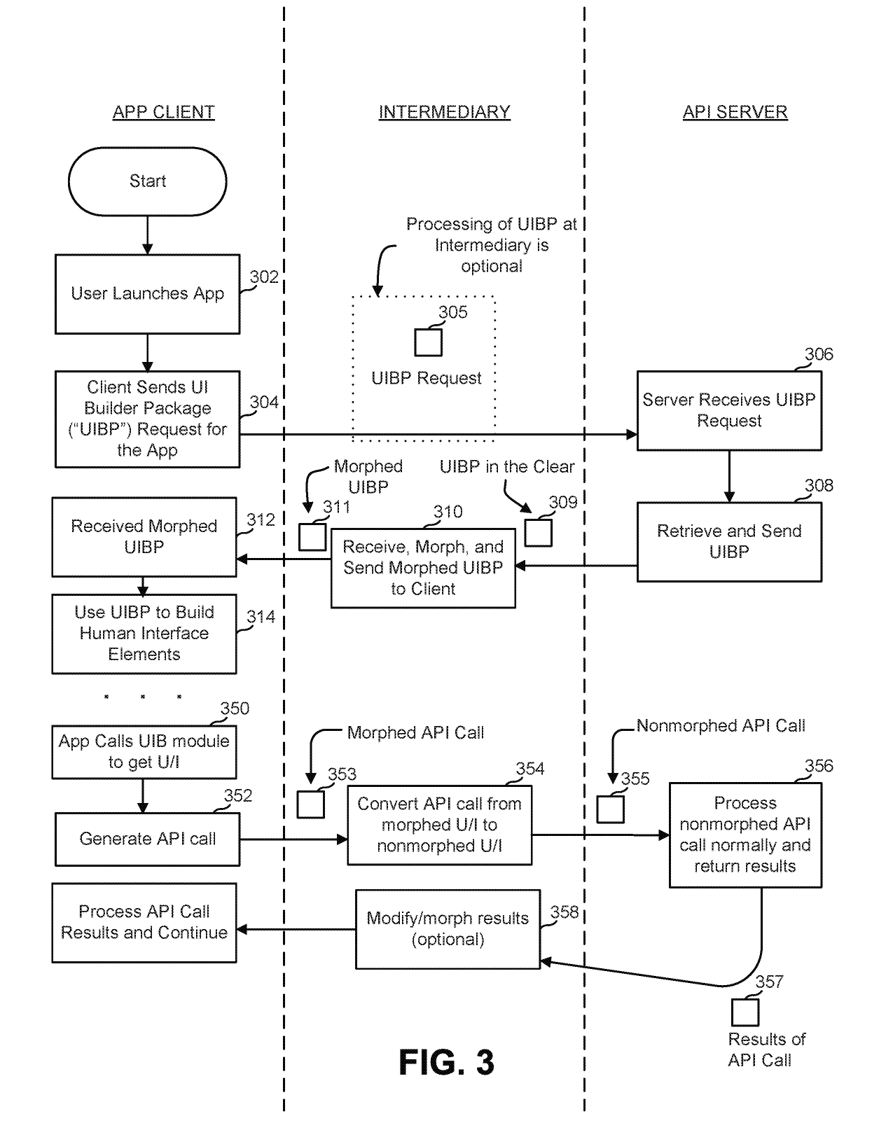

FIG. 3 is a swim diagram illustrating interactions of an app, an intermediary, and an API server. In this example, it is assumed that the API server has the necessary user interface components. When a user launches an app using the user's client (step 302), which might be by opening or starting the app, the client sends a UIBP request 305 associated with the app to the API server. In some embodiments, UIBP request 305 passes through the intermediary and is processed or passed through unprocessed. In some embodiments, parts of the intermediary are implemented at the app/client side.

The API server receives UIBP request 305 (step 306) and then retrieves the corresponding stored UIBP and sends it towards the client (step 308). In implementations where all UIBPs are generated on the fly, the corresponding UIBP might be generated instead of being retrieved from storage. The sent UIBP 309 is “in the clear” in that it is easily understood by a client, a reader and/or the API server. In step 310, the intermediary receives UIBP 309, morphs it (examples below) and sends a morphed UIBP 311 to the client. The client receives the morphed UIBP 311 (step 312) and then uses it to build human-interaction elements (step 314). Examples of these processes are described in more detail herein.

With the morphed UIBP available to the client, the client can use that as needed to handle human interactivity. When the client app was launched, it contacted the API server (e.g., a “phone home”) operation to retrieve a fresh copy of the UIBP containing human-interaction APIs and user interface components.

Suppose that while the app is executing, the app wants to have some interaction with the user and then make a request of the API server using that interaction. As an example, suppose the app needs to authenticate with the API server. The app might prompt the user to enter a username and password, code or passphrase. Once the user enters that information, the app would make an API call to the API server and with that API call submit authentication information. Doing this with standardized API calls would allow an interloper monitoring the API calls and responses to determine the structure and nature of the API calls and how they work. But just simply using a morphed UIBP, the resulting display might not be intelligible. To deal with this, the app uses the downloaded UIBP and a client-side user interface generator tuned to the particular UIBP and user device.

Continuing to reference FIG. 3, a user interface builder (UIB) is used at the client side to handle the user interface given that the instructions are represented by the morphed UIBP. At step 350, the app intends to perform a human interaction operation, using the morphed UIBP. The app calls the UIB to perform the necessary human interaction, then the UIB generates the appropriate API call that is itself morphed (step 352). The morphed API call 353 reaches the intermediary, which then converts (step 354) the morphed API call into a nonmorphed API call 355 and sends that to the API server. The API server processes nonmorphed API call 355 in the normal course (step 356) and returns the results 357. The results 357 might be provided directly to the app, but if they are provided to the intermediary, the intermediary can modify/morph the results (step 358) before sending the results to the client. The client can then process the results of the API call that corresponded to the human interface operation.

Using these techniques, automated attacks on API servers can be reduced. As API servers become more widespread, especially in the area of mobile computing, they will bring convenience to application developers, but one downside is that the API server comes with security vulnerabilities. Adversaries can develop simple scripts to call APIs, including those supposed to be triggered by human users only, and launch sophisticated automated attacks, e.g., credential stuffing and automated account creation. By applying the methods described herein, automated attacks on API servers can be disrupted.

As explained above, an app manager analyzes the APIs provided by an API server, identifies the subset of APIs that are supposed to be triggered by human users only—the HI-APIs. A user interface (UI) component (text, image, etc.) is designed for each HI-API and those HI-APIs and their UI components can be made into a UIBP. When a client app is launched, the app requests from the API server a fresh copy of the API server's UIBP. The client app can then use the UIBP to create user interfaces to the HI-APIs. An intermediary (device, system, software, etc.) is between the API server and client apps. The intermediary intercepts the UI Builder and transforms the API information into disassociated strings (e.g., randomized strings or strings subject to a complex conversion), thus effectively applying polymorphism on the HI-APIs. Client apps use the transformed UI Builder to build user interfaces. Subsequent calls to the HI-APIs can then happen on the transformed APIs. The intermediary might also intercept all client requests on the transformed HI-API, and restores them to their original form. The whole transformation process can be opaque to the API server. With the polymorphism introduced, the HI-APIs are no longer vulnerable to automated attacks. Because the APIs can change every time at app launch, and the values are disassociated, there is no static information adversaries can exploit to write attack scripts.

In some embodiments, such as where a client app executes for a very brief time or for a very long time, the time between refreshes is not optimal. For example, an attacker might automate a simulated repeated launch of the app, to gain statistical information about the user interface, or might cause the app to remain launched so that the UIBP is not refreshed. A malicious application might request a fresh UI Builder, analyze the traffic and store the transformed API components, and then programmatically re-use these transformed APIs in the same application process lifetime. To defeat this evasion, the UI Builder might include a configurable timer. When the timer expires, the intermediary will consider subsequent requests to be unauthorized/automated attacks, and take necessary actions. The timer might be encrypted or obfuscated to defeat simple interception attacks.

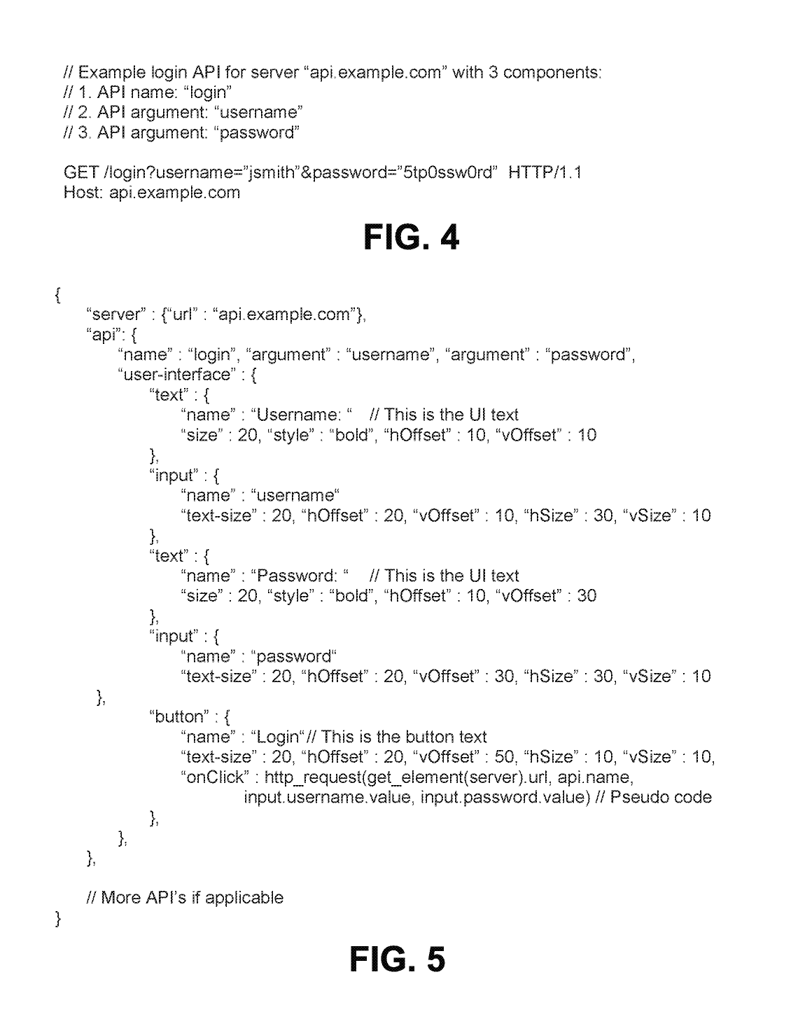

FIG. 4 illustrates an example of dynamic user interface generation. The example shown there is text that might be used to specify a particular API call using a URL and its arguments. In this example, the API call generates the following HTTP request:

GET /login?username=”jsmith”&password=”5tp0ssw0rd” HTTP/1.1
Host: api.example.com

That text can be processed by a dynamically generated user interface, with the following as the transformed API call:

GET /s1ty56fuoo8e?u6rts80xytfab=”jsmith”&3ergs8xvqs3t=”5tp0ssw0rd” HTTP/1.1
Host: api.example.com

When this API request reaches the intermediary, the intermediary will recognize that this is an HI-API call with transformed API components. The intermediary will then restore it to the original form before passing it to the API server. This example is for an authentication process. Other processes can be dealt with in a similar manner.

For example, an account registration process might be handled by an API call register( ):
API: register
   Argument: first_name
   Argument: last_name
   Argument: email
   Argument: password
   Argument: password_retype
   Argument: SSN

The original HTTP request for this register( ) call might be:

GET
/register?first_name=”John”&last_name=”Smith”&email=jsmith@email.example.com
&password=”p055w0rd”&password_retype=”p055w0rd”&ssn=”123456789”
Host: api.example.com

The transformed API call for this register( ) call might be:

GET
/x8rTuV94eRtfm?e8rt89rfse4tr8=”John”&q3Rt4Yuy98rtbv=”Smith”&=jsmith@email.
example.com&B4xhgRt8AsDvY=”p055w0rd”&R4tgherF9vrty3”p055w0rd”&Z7fhasdft
8rte=”123456789”
Host: api.example.com

As another example, a money transfer might take the form of:
API: transfer
   Argument: from_account
   Argument: to_account
   Argument: amount

The original HTTP request for this transfer( ) call might be:

GET /transfer?from_account=”123454321”&to_account=”456787654”&amount=900
Host: api.example.com

The transformed API call for this transfer( ) call might be:

GET
/Y87eretFg3thg?utyzEt7rzta=”123454321”&Wer8TZhg0it=”456787654”&Q3ert5Ytz3ft
=900
Host: api.example.com

As yet another example, a file sharing call might take the form of:
API: file_share
   Argument: file_path
   Argument: share_to

The original HTTP request for this file_share( ) call might be:

GET /file_share?file_path=”/documents/share/xyz.pdr&share_to=”all”
Host: api.example.com

The transformed HTTP request for this file_share( ) call might be:

GET
/Rasdfase7nbert09x?vdc4retzef9t=”/documents/share/xyz.pdf&uiorepq3asd54=”all”
Host: api.example.com

An API server typically supports a long list of APIs that are used for back-end operations. A first step is to identify a subset of the APIs to protect against automated attacks. These APIs, which we call human-interaction APIs, are supposed to be triggered by human users only, but if they are used by automated processes, programmatic triggering of them can cause server malfunction. These can be associated with a user interface. An HTTP intermediary protects the human-interaction APIs with polymorphism. The other APIs, which can be called by a program, will bypass the protection process.

FIG. 5 illustrates an example of a user interface builder package (“UIBP”), in pseudo code form, as might be sent from an API server. Generating the UIBP for the client apps can be a one-time task on the API server side. Once the HI-APIs are identified, a user interface is created for each HI-API and those HI-APIs need only be made available through an associated user interface. That way, any direct access, without going through the associated user interface, will be considered as automated attack and blocked or processed accordingly. The UI Builder Package (“UIBP”) contains the details of the HI-APIs and their corresponding user interfaces. While the example of FIG. 5 illustrates an example UI Builder containing only one human API (e.g., “login”), there could be multiple human HI-APIs in a UI Builder.

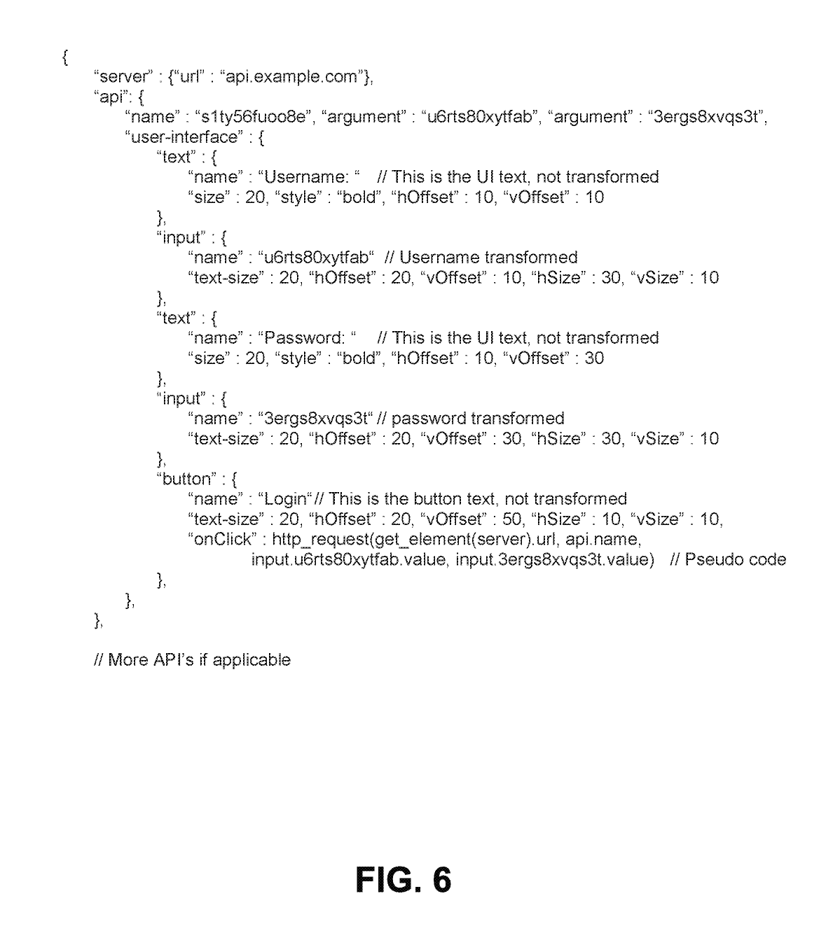

FIG. 6 illustrates an example of a user interface builder package (“UIBP”), transformed by an intermediary for use by an app to generate user interface elements. When a client app contacts the API server to retrieve a fresh copy of the UI Builder (such as each time the client app launches or at other times, the intermediary intercepts the UI Builder message (the UIPB) and transforms the API information, while keeping the user interface texts unchanged. This way the client apps may present consistent user experience, while the underlying APIs have polymorphism. For the most part, with the transformation, only human users, through the UI, can correctly trigger the APIs. FIG. 6 illustrates a transformed UI Builder. Client apps can use that UIB to create a user interface with two text fields (“Username:” and “Password:”), two input fields (username and password) and one login button.

In specific deployments and implementations, the API Server identifies the HI-APIs, creates a UI for each HI-API and packages that into the UI Builder Package. The API server will respond to client app's initial message requesting the UI Builder.

The client application can then remove direct usage of all HI-APIs, implement UI Builder request messages in the app's launch process (e.g., a “Phone Home” function), execute a stub function to build a consistent UI for all HI-APIs based on the received UI Builder. The stub function does not need to understand the UI Builder's implementation. The stub function can simply treat the UI Builder as one single entity and trigger it. The UI Builder should be self-contained to construct the user interface for the particular app. Third-party apps and the supplied client app will have the same level of knowledge of the UI Builder. Preferably the UIBP messaging is done over an SSL/TLS channel or other secure channel to avoid man-in-the-middle attacks. The client app should also be configured to not use expired UI Builders.

The intermediary will intercept UI Builder messages from API servers, transform API components in the UI Builder message with polymorphism, intercept client requests on the transformed HI-APIs, and restore transformed HI-APIs and present the original ones to the API server. The intermediary can be configured to not process any APIs that are not in the list of HI-APIs.

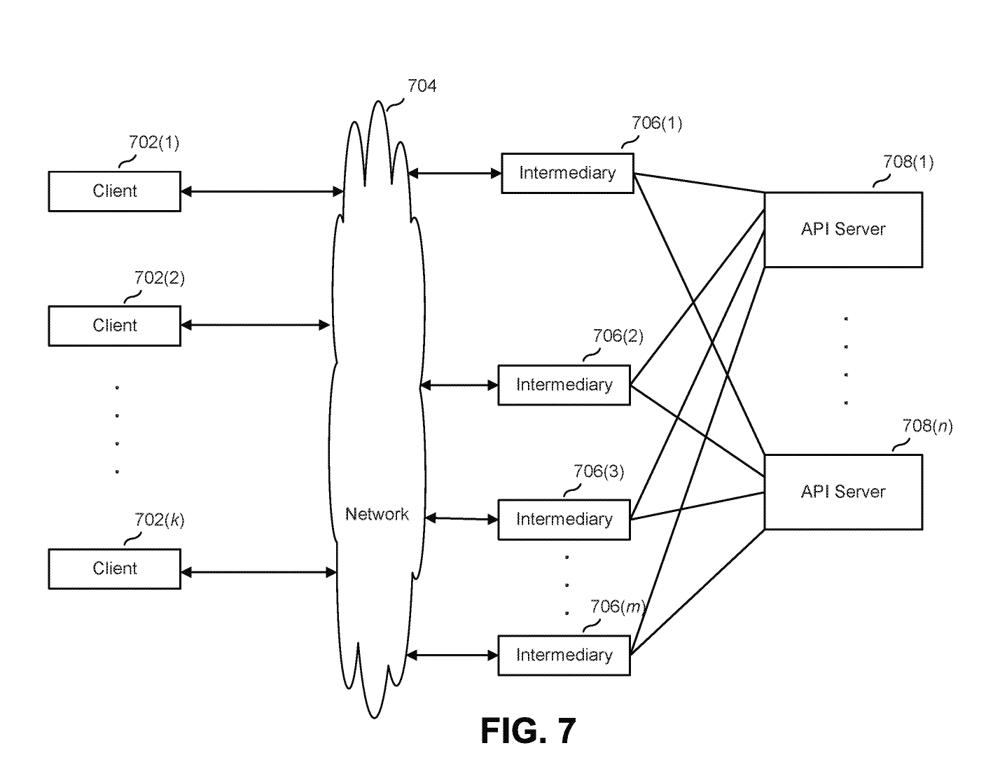

FIG. 7 is a block diagram of a larger system comprising a plurality of clients and a plurality of servers. In some embodiments, each intermediary serves exactly one API server. In other embodiments, an intermediary serves multiple API servers and/or multiple intermediaries serve all or some of the traffic for a given API server. For high availability, it might be preferable to have multiple intermediaries that can serve a given API server. As illustrated in FIG. 7, multiple user devices operate as clients 702, coupled to a network 704, with intermediaries 706 coupled to network 704 as well and API servers 708 interacting with intermediaries 706. Although the paths between intermediaries and API servers is shown as being distinct from network 704, that is for clarity and it is entirely possible that traffic between clients and intermediaries and traffic between intermediaries and API servers go over the same network.

A user device or app server, etc. might include various components. For example, a user device might comprise a central processing unit (“CPU”), random access memory, storage for data values such as a private key and an UEID, a network interface and an input/output interface. A system bus might connect the various components.

Example user devices include a mobile telephone, a portable computer, a handheld tablet, and an embedded computing device that has network connectivity. An example human interface operation that might be performed using the systems or methods described herein is an operation of obtaining one or more authentication parameters from a human user of the user device. In some cases, all API calls made by the native application are treated as API calls involving a human interface operation even when the API call is for an operation performed by the native application that uses no human user interface elements.

An intermediary might maintain whitelists or blacklists for use in filtering out requests from clients, which might be legitimate clients or hacked clients.

Typically, the CPU capable of processing instructions for execution that it reads from program code storage, which might be RAM, ROM, flash, magnetic storage, etc. The CPU may be designed using any of a number of architectures, such as a CISC (Complex Instruction Set Computer) processor, a RISC (Reduced Instruction Set Computer) processor, or a MISC (Minimal Instruction Set Computer) processor. The CPU might be a single-threaded processor or a multi-threaded processor. Additional functionality might be provided by a graphics I/O system and processor.

In some implementations, the memory used is a computer-readable medium, such as a volatile memory unit or a non-volatile memory unit. Various storage devices might be capable of providing mass storage for various needs. For example, in one implementation, storage devices comprise flash drive devices, floppy disk devices, hard disk devices, optical disk devices, tape devices, or the like.

Input/output devices might include a keyboard and/or pointing device and a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device.

A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data. Storage devices suitable for tangibly embodying computer program instructions and data include many forms of non-volatile memory, including, by way of example, semiconductor memory devices, such as EPROM, EEPROM, and flash memory devices, magnetic disks such as internal hard disks and removable disks, magneto-optical disks; and CD-ROM and DVD-ROM disks.

The processor and the memory can be supplemented by, or incorporated in, ASICs (application-specific integrated circuits). To provide for interaction with a user, the features can be implemented on a computer having a display device such as a CRT (cathode ray tube) or LCD (liquid crystal display) monitor for displaying information to the user and a keyboard and a pointing device such as a mouse or a trackball, or a touchscreen, by which the user can provide input to the computer. Additionally, such activities can be implemented via touchscreen flat panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by some form or medium of digital data communication such as a communication network. Examples of communication networks include a local-area network (“LAN”), a wide-area network (“WAN”), peer-to-peer networks (having ad-hoc or static members), grid computing infrastructures, and the Internet.

The computer hardware described herein might be used with the computer software described herein unless otherwise indicated. The software can be written in one or more languages and be stored in different forms of memory or storage. The computer hardware described and illustrated might include various forms of digital computers, such as laptops, desktops, workstations, personal digital assistants, servers, blade servers, mainframes, and other appropriate computers.

The user device might include mobile devices, such as personal digital assistants, cellular telephones, smartphones, and other similar computing devices. Additionally the system can include portable storage media, such as Universal Serial Bus (“USB”) flash drives. For example, the USB flash drives may store operating systems and other applications. The USB flash drives can include input/output components, such as a wireless transmitter or USB connector that may be inserted into a USB port of another computing device.

The computer system can include clients and servers. A client and server are generally remote from each other and typically interact through a network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Other implementations are within the scope of the following claims. Similarly, while operations are depicted in the figures in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Further embodiments can be envisioned to one of ordinary skill in the art after reading this disclosure. In other embodiments, combinations or sub-combinations can be advantageously made. The specification and figures are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. For use with a user device comprising an electronic device having a human user interface, client software that can execute on the user device, the client software comprising:
a native application that performs at least one human interface operation that requires human user input or output for proper execution of the at least one human interface operation and that performs at least one application programming interface (“API”) operation that uses an API for proper execution of the at least one API operation;
an interface requestor that requests from an API server or its agent a user interface builder package corresponding to the native application;
storage for user interface builder packages retrieved from the API server or its agent; and
a user interface builder that receives requests from the native application for human interface associated with an API call, generates a user interface element according to the request and the user interface builder package, performs the human interface operations or has the native application perform them, and indicates at least one parameter for the API call, wherein structure of the API call is disassociated in the user interface builder package so as to prevent at least some attempts to simulate the at least human interface operation using an automated process.

2. The client software of claim 1, wherein the client software is program code that is executable on one or more of a mobile telephone, a portable computer, a handheld tablet, or an embedded computing device that has network connectivity.

3. The client software of claim 1, wherein the at least one human interface operation is an operation of obtaining one or more authentication parameters from a human user of the user device.

4. The client software of claim 1, wherein all API calls made by the native application are treated as API calls involving a human interface operation even when the API call is for an operation performed by the native application that uses no human user interface elements.

5. The client software of claim 1, wherein the user interface builder packages are user interface builder packages created by an app manager distinct from the API server.

6. The client software of claim 1, wherein the user interface builder packages are user interface builder packages created by an app manager distinct from the API server and further modified by a network intermediary distinct from the API server and distinct from the user device.

7. The client software of claim 6, wherein the user interface builder packages are further modified by the network intermediary by transforming API information into disassociated strings to effectively apply polymorphism to API calls.

8. The client software of claim 1, wherein the user interface builder packages are user interface builder packages modified by a network intermediary to alter API calls from having the API server as a destination to having the network intermediary as the destination.

9. The client software of claim 1, further comprising program code, executable by the user device, for sending polymorphic API calls over a network, wherein an API call is polymorphic if instances of the same API call are different enough from other instances to prevent at least some attempts to simulate a human interface operation using an automated process.

10. The client software of claim 1, further comprising program code, executable by the user device, for sending nonmorphed API calls, wherein an API call is nonmorphed when it is understandable to an API server as an API call from a native application client.

11. The client software of claim 10, further comprising program code, executable by the user device, for determining whether to send an API call as a polymorphic API call or as a nonmorphed API call.

12. The client software of claim 11, wherein determining is determining based on lists used for filtering out requests from clients, which might be legitimate clients or hacked clients.

13. An app-API initializer comprising:
program code, executable by the app-API initializer, for analyzing a native application to determine a set of API calls that the native application uses;
program code, executable by the app-API initializer, for determining which calls of the set of API calls are human-interface API calls or are non-human-interface API calls, wherein a human-interface API call is an API call that, in expected operation, necessarily involves at least one human interface operation and a non-human-interface API call is an API call that, in expected operation, would occur without human user interaction; and
program code, executable by the app-API initializer, for generating a user interface builder package, wherein the user interface builder package comprises instructions for use by a native application to make the human-interface API calls.

14. The app-API initializer of claim 13, further comprising:
program code, executable by the app-API initializer, for morphing the user interface builder package into a morphed user interface builder package that comprises an instance of a polymorphic API, wherein not all instances of the native application receive the same polymorphic API; and
program code, executable by the app-API initializer, for sending the morphed user interface builder package to a destination on a network.

15. The app-API initializer of claim 14, wherein the destination on the network is a network intermediary distinct from an API server and distinct from a native application client.

16. The app-API initializer of claim 14, wherein the destination on the network is a native application client.

17. The app-API initializer of claim 13, wherein the app-API initializer is distinct from an API server that responds to the API calls.

18. The app-API initializer of claim 13, wherein the program code for determining which calls of the set of API calls are human-interface API calls or are non-human-interface API calls comprises program code for performing a heuristic process.

19. The app-API initializer of claim 13, wherein the program code for analyzing a native application to determine a set of API calls that the native application comprises program code for performing a heuristic process.
